(19) United States
(12) Patent Application Publication
(10) Pub. No.: US 2003/0045275 A1
(43) Pub. Date: Mar. 6, 2003

(54) Communication method and apparatus

(76) Inventors: Brendan McDonagh, Dublin (IE); Stan Danilov, Dublin (IE); John McGeever, Dublin (IE)

Correspondence Address: JACOBSON HOLMAN PLLC, 400 SEVENTH STREET N.W., SUITE 600, WASHINGTON, DC, 20004, US

(21) Appl. No.: 10/277,058

(22) Filed: Oct. 22, 2002

Related U.S. Application Data
(63) Continuation of application No. PCT/IE01/00054, filed on Apr. 26, 2001.

(30) Foreign Application Priority Data
Apr. 27, 2000 (IE) 2000/0317

(51) Int. Cl. H04Q 7/24; H04B 5/00; H04M 3/42

(52) U.S. Cl. 455/414; 455/41

(57) ABSTRACT

A piconet of consumer devices (1) communicate with the Bluetooth protocol, and a mobile phone (2) automatically captures consumer data including user data and device data. The mobile phone (2) has a Bluetooth interface, a mobile network interface, and a bridging circuit between them. The bridging circuit is used to automatically update a management system (2) with captured data via the mobile network. The management system (3) uses the captured data to update a user profile. It then uses the profile data to filter available services and push the selected services to the user.

### FIELD OF THE INVENTION

The invention relates to communication between consumers of services and remote servers hosted by organisations providing the services.

### PRIOR ART DISCUSSION

To date a good deal of work has been done in developing services for consumers using mobile devices so that they are offered in a more user-friendly manner. This is important because growth of so-called m-commerce requires that the service offerings become mere meaningful (“personalised”) and easily accessible for subscribers.

WO00/65809 (Telia) describes a system and method for introducing new services to mobile telephone subscribers. The subscribers control personalisation by using a PC to gain online access to the server to upload personalisation information. While this approach improves user-friendliness because services are personalised, there is still a barrier limiting the extent to which remote services are availed of by subscribers. This is the fact that personalisation is passive insofar as the user is required to actively go online and upload the required personalisation instructions. Thus, personalisation appears to be due to only as good as the proactive efforts of the user.

The invention addresses this problem.

### SUMMARY OF THE INVENTION

According to the invention, there is provided a communication method carried out by a user mobile device and a remote management system, the method comprising the steps of:—

(a) the mobile device automatically capturing consumer data from a wireless local area network of consumer devices according to a local wireless protocol,

(b) the mobile device automatically uploading said captured data to the management system via a mobile network; and

(c) the management system receiving the captured data and using it to automatically update a user profile database with user profile data for use in making service offers to the user.

In one embodiment, the method comprises the further step of the management system making service offers to the user according to the user profile data.

In another embodiment, the management system automatically pushes service offers to the user.

In a further embodiment, the wireless local area network is a piconet operating according to the Bluetooth standard.

In one embodiment, the capturing step (a) comprises capturing:

attributes of said consumer devices;

user-specific data from a mobile device memory; and

status data for the wireless local area network including data relating to addition or deletion of consumer devices.

In one embodiment, the step (b) is carried out by a collection function in the mobile device and a data store function in the management system.

In another embodiment, the uploading step (b) is performed by the mobile device interfacing with the local wireless network, interfacing with the mobile network, and bridging between said interfacing operations.

In one embodiment, the updating step (c) is performed by a store function of the management system, and it comprises storing a return address for service offers.

In one embodiment, the updating step (c) comprises the sub-steps of:—

updating the user profile database with captured user profile data,

updating a service database with captured service data originating in the wireless local area network, and

updating captured connection data for pushing service offers to the user.

In one embodiment, the updating step (c) comprises updating a service type database with user profile data, and an external entity updating said database with service type data.

In one embodiment, the steps of the management system making service offers comprises the sub-steps of:—

retrieving user profile and service data, and

matching the service data with the profile data to determine a suitable service.

In one embodiment, the service offer step comprises the further sub-steps of matching the service data with data relating to a user service request.

In another embodiment, the management system stores service type attributes in a service type database and uses said attributes for matching the service data with the profile data.

In one embodiment, a service delivery function of the mobile device makes the service offer in response to instructions from a service matching function of the management system.

According to another aspect, the invention provides a management system comprising:

means for interfacing with a mobile device in a wireless local area network of consumer device;

a data store function comprising means for receiving captured consumer data from the mobile device, and for using the captured data to update a user profile database;

a service management function comprising means for updating a service database with service data; and

a service matching function comprising means for parsing user profile data and service data to determine service offers to be made to the mobile device in a personalised manner.

In one embodiment, the system comprises a service type function comprising means for updating a service type database with service type attributes, and the service matching function comprises means for using said attributes for choosing personalised services to offer.

In another embodiment, the system comprises means for updating the service type database using data for services provided by external entities.

In one embodiment, the system comprises means for registering a service type from an external entity as a trigger.

In a further aspect, the invention provides a mobile device comprising:

an interface for interfacing with consumer devices in a wireless local area network,

an interface for interfacing with a mobile network,

means in the consumer device interface for routing captured device data to the mobile network interface, and

means in the mobile network interface for uploading said captured data to a remote management system.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a high level diagram illustrating the components and network domains of the invention; and

FIG. 2 is a flow diagram illustrating data flows between components in more detail.

### DETAILED DESCRIPTION OF THE EMBODIMENTS

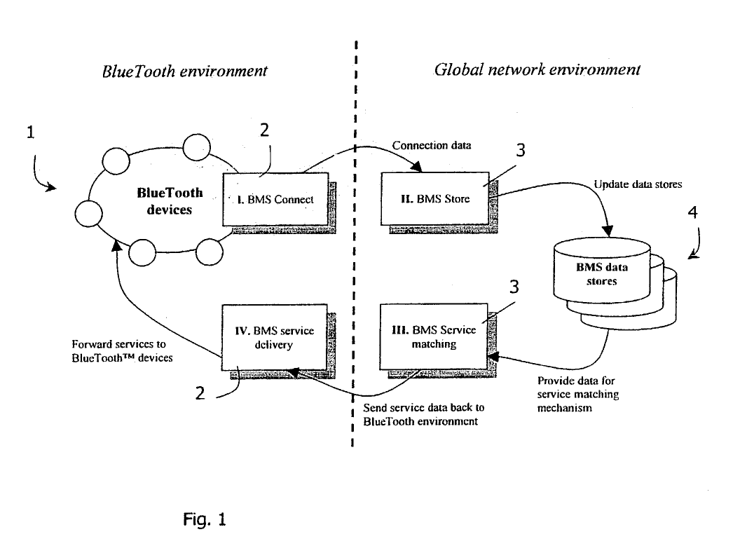

Referring to FIG. 1 a communication method of the invention involves consumer devices 1 which are Bluetooth-enabled and which communicate locally in a piconet. While in this description the local network or piconet is provided by Bluetooth functionality, it is envisaged that the invention would be equally applicable to other wireless local area networks (WLANs) such as 802.11, 802.11b (Wi-Fi), 802.11a, 802.15 and HomeRF which operates in a limited coverage area (15-200 m) and has a nominal speed of 1-11 Mbps (actual throughput of 700K-5 Mbps). Typically, WLAN systems have two basic components, a station adapter which connects to the client computer and an access point connecting to wired LAN infrastructure with the majority of the technologies permitting ad hoc networks. For local networks based on technologies other than Bluetooth to provide the same functionality it is necessary to have additional software for collecting information about types of devices connected to the network, their capabilities, IDs and other.

A consumer's mobile phone 2 includes software which forms a bridge between the Bluetooth domain and the mobile network domain. The mobile network in turn interfaces with the Internet using gateways and with other external sources of services, together referred to as the Global Network Environment.

At a high level, in a step I the mobile phone 2 connects with a Bluetooth management system (BMS) 3 and, transparently to the user, uploads data concerning the Bluetooth devices 1. The data is collected using the Service Discovery Protocol Bluetooth mechanism. In a step II the BMS 2 processes this data and updates a consumer personalisation database 4 to improve personalisation of service offers for the user of the mobile phone 2. The BMS 3 then, in a step III matches the personalisation attributes with available services. In a step IV it proactively transmits via the mobile network service data to the user's mobile phone 2. The phone 2 then, using its bridging interfaces, forwards services data to the Bluetooth devices 1.

It will be appreciated that the personalisation database 4 is effectively automatically updated without intervention by the user and there is no need for him or her to take any action. Also, the user does not even need to request services as they are dynamically offered by the BMS 2. The service offerings may stop at the mobile phone 2 or they may, as illustrated in FIG. 1 be routed onwards to the Bluetooth devices 1.

While in the embodiment illustrated the BMS 3 makes the service offers, it is envisaged that they may be made by other servers using data received from the BMS 3.

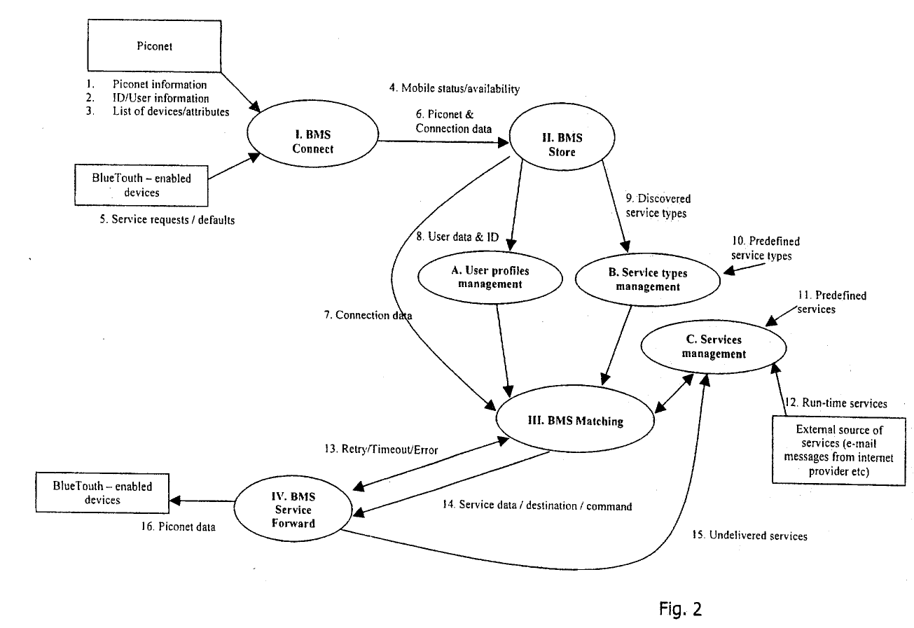

In more detail, the following are the signal details, with reference to FIG. 2.

1. Piconet information—data specific to the piconet technology.

2. User ID/User information—user data collected from the mobile terminal. In some cases the user will be asked to provide the user ID explicitly for authentication purposes (for example, in order to access a bank account).

3. List of available services—list of services provided by devices participating in a piconet, and their attributes including types.

4. Mobile status/availability—information on the availability of the mobile terminal.

5. Service requests—optional service requests from BT devices.

6. Piconet & connection data—all of the above except 1 and 4.

7. Connection data—information for creating the route for the information that is sent back to the BT environment.

8. User data & ID—data to be added to a user profile in the data store.

9. Discovered service types—service types can be discovered “on the fly” and sent by the BT environment—will be used to update the data store of the services.

10. Predefined service types—predefined service type information entered by the operator offline. The operator can maintain service type information specific to the network and update service attributes at any time.

11. Predefined services—service data entered by the operator in the offline mode—it is added to the database of services (instances of service types) that can be provided and sent to users (including those that the operator failed to deliver in the past). For example, a constantly updated table of currency rates that can be offered to interested users. Alternatively predefined services could be triggers that inform external service providers that a user capable of processing a service offer has connected to the network. In that case the external service provider will be responsible for sending service data to the user.

12. Run-Time services—services that are created in run-time. For example—the network detects an e-mail received for a particular user. The e-mail message becomes a service of type “E-mail message delivery” that is stored in the database and can later be sent to the user when he establishes a connection. Run-Time services can originate in the operator's network or can come from external networks that communicate with the operator's network. Services provided by external networks can be registered in databases as triggers. If a user capable of processing a particular service connects to the BMS the external network will be notified by means of triggers stored in databases.

13. Retry/Timeout—mechanism supported by BMS service matching and BMS service forwarding functions. If service data is not delivered to the user (which could be signalled by an exception, timeout or an invalid return code) the service will then be returned to the database services. The service will be ready to be sent next time the user establishes a connection with a piconet containing devices of similar types (for example an mp3 if the service is a collection of music records).

14. Service data/Destination/command—data sent to the piconet connection which includes the service itself, its destination (identifier of a BT-enabled device for example) and a command (request) specifying what action is to be taken by the piconet (for example, turn down the volume of a BT-enabled player and inform of the receipt of an SMS message, or simply display an email on screen of a BT-enabled PC).

15. Undelivered services—return back services to the data store so that they will be available for forwarding next time the user connects to the network. The service data is not sent physically back to the data store. When the BMS service matching function decides that a service should be sent to the BlueTooth environment, the service data in the store is marked as being sent to the BlueTooth environment. It would protect the service matching function from selecting the service again while the service is in the “marked” state. If the delivery of the service fails for any reason the service matching module will be informed of the failure. It can be informed by an exception raised in a service delivery function, by a returned error code or a timeout. The service matching function then requests a service management function to unmark the service thus making it again available in the database. If the service is delivered successfully, the service management function will be notified as well and will delete the marked service data from the database.

16. Piconet data—data sent to the BlueTooth enabled devices. This data is specific to the implementation of BlueTooth device hardware and software. Devices should be able to recognise and process the service data.

A major advantage of the invention is that while the overall flow of steps I to IV is very different from what has been done heretofore several of the software and hardware technology units required at the various nodes are readily available. For example, the WAP Push Framework using a Push Initiator may be used for step III. This technology is described in the public domain. Also, the automatic capture of local data is a feature of the Bluetooth standards. The bridging interface of the mobile phone 2, however is not available, but is a manufacturer and network specific module comprising Bluetooth embedded software, the Global Network software and a set of commands (command protocol) that allow Bluetooth-to-Global Network communication. Depending on the type of the Network (GSM, GPRS, 3G etc), bearer (SMS, WAP, IP based connection etc) and capabilities of the mobile terminal (WAP enabled, SMS enabled, Java enabled etc) the implementation of the interface can vary significantly.

Regarding the BMS functionality it is relatively simple to perform the database management and service matching operations once the user-domain data and services data is available from the mobile phone 2 and operator systems respectively.

The main logical functions defined by their roles in the steps I to IV, are Connection, Service store, Service matching, and Service delivery. Depending on different implementation details the steps can be performed either in the Bluetooth Environment (I and IV) or in the Global Network environment (II and IV). In certain scenarios multiple steps are performed by one device. For example, if the Bluetooth environment consists of a BT-enabled personal computer and a mobile terminal (mobile phone) forming a piconet, connection (I) and forwarding (IV) can be together in the mobile terminal or the PC can have some of the forwarding functionality implemented in it's software. The following are the primary operations of each step.

I. Connection

Gathering piconet data: number, type and attributes of participating BT-enabled devices, user IDs of owners of devices (used for authentication purposes later) etc.

Collecting user-specific data from the mobile terminal (user ID, authentication information etc).

Gathering piconet information required for specifying service offers.

Forwarding the information to the Global Network Environment.

Reporting changes in the status of the piconet devices. When a new device joins the piconet, its capabilities (supported services) should be sent to the Global Network.

This step is performed by a hardware part (specific to the piconet technology) and an embedded software part which is responsible for user and service data processing.

II. Update/Store

Receiving piconet information previously gathered in the connection step.

Supplying the data to user profile management, service type management and service management databases.

Providing connection data for a BMS service matching function, which is used for setting the route for the data to be sent back to the BT environment (piconet connection).

Manipulating the incoming data, and issuing queries against databases.

III. Service Matching

Collecting user profile, service type, and service data.

Matching the obtained data against the data received from the piconet. Filtering service data using information collected and stored in the user profile database.

Creating a set of services (service data).

Sending service data back to the BT environment.

Services that are not delivered to the piconet will be returned. When a piconet with the same user and the same type of BT-enabled devices is created, the system tries to send previously undelivered service data to the BT environment. It is implemented by a software function located in the Global Network environment. The BMS service matching function relies upon the functionality of user profile management, service type management, and service management functions.

IV. Service Delivery

Receiving the service data from the BMS service matching function.

Informing the BMS functions in the operator's domain of failure or success of the operation.

Forwarding data to the piconet devices depending on service data and the type of command received.

Offer services using the mobile terminal.

Service delivery is performed by a hardware part (specific to the piconet technology) which is responsible for redirecting data to piconet devices, and an embedded software part which processes received service data and notifies the user of the service arrival (if the type of the service requires user notification). The location is the BT environment, either together with or separately from the BMS service forwarding function.

This following describes in more detail the overall process of sending connection data from the Bluetooth environment to the Global Network, processing the data and sending offers back to piconet devices.

I). Establishing Connection

When a mobile terminal (mobile phone, Bluetooth enabled PDA etc) detects a piconet of Bluetooth-enabled devices it establishes a connection with the devices using Bluetooth protocols. The BMS connection function creates a list of available Bluetooth devices. The BMS connection function detects services provided by devices using the Bluetooth Service Discovery Protocol (SDP) and by additional high level software written for the application layer of the BlueTooth protocol stack and combines this information with user data available from the mobile terminal including user ID and optional user profile data. The BMS connection function also sends data to the Global Network when a new BlueTooth device joins the piconet. Such a new connection triggers the service matching function in the BMS 3 and can receive new service offers from the Global Network. The BMS 3 maintains a unique address of the piconet, which will be used by the BMS service delivery function to forward service data back to BlueTooth devices.

For BlueTooth devices and the BlueTooth enabled terminal to communicate both the devices and the terminal must understand a predefined set of commands that will be sent between the devices to perform certain tasks (provide user information, acknowledge successful receipt of data, request service description etc). The set of commands or, the command protocol is technology-specific.

The command protocol is used by software in the BlueTooth enabled devices, in the mobile terminal, and in the BMS service delivery function. The above data is sent to the BMS service store function for processing. Depending on capabilities of the mobile terminal the user can have a choice of initiating the request of services from the Global Network. In that case the BMS connection sends all of the information about the existent piconet (if any) along with the specific request/command issued by the customer who uses the mobile equipment.

II). Updating BMS Data Stores

Data sent from the BMS connection function is received and parsed by the BMS service store function. The BMS 3 maintains data stores of user profiles, service types, and services. User information contained in the data received from the Bluetooth environment (user ID and optional user profile data) is used to update user profile data stores. This information can be retrieved at any time in the future to make an up-to-date profile of the customer and is required for customising service offers that are sent to end users. After the profile data store has been updated the data from the piconet is passed to the BMS service matching function.

III). Service Matching

The BMS service matching function is responsible for analysing the data coming from the Bluetooth environment, identifying appropriate services, and customising service offers based on user information stored in the user profiles database stores. Data received from the BMS connection function contains the list of available services provided by Bluetooth devices that form the piconet. The BMS service matching function scans data stores of services and finds services that can be offered to known piconet devices, or that have been explicitly requested by those devices. Based on the information stored in user profile data stores the matching function filters out services that are not suitable for the user with that ID. Information about the user is constantly updated by the operator of the network, and by the user himself who can access the data stores and enable or disable certain services. Customised service offers are then sent back to the Bluetooth environment by the BMS service delivery function. To deliver the data to the correct piconet the system uses the piconet address obtained by the BMS connection function.

IV). Service Delivery

Processed service data (customised service offers) are delivered to Bluetooth devices and, optionally, the user could be notified of their arrival. The command (request) is used to identify possible actions that should be taken to deliver the service offer. The service can be displayed on the screen of the mobile terminal, passed on to a particular Bluetooth device “consciously” or “subconsciously” or the user could be notified and asked to make a decision as to how to process the service data. The service delivery function is responsible for handling errors. If the mobile terminal leaves the piconet and a Bluetooth device is no longer accessible the BMS service delivery function informs the service matching function of the failure to deliver the service. In case of a failure the BMS service matching function returns offered services to the data stores. Attempts are undertaken to deliver the returned services when the user establishes a connection with a piconet that contains devices capable of processing such service offers. If the BMS service delivery function processes the service successfully the BMS service matching function is sent an acknowledgement message and the service data is deleted form the database.

The service is returned to the data store 4 automatically if the BMS service delivery function does not respond with an acknowledgement message within a certain period of time. The communication protocol of the BMS connection function is supported by the BMS service delivery function. The function uses a subset of commands from the protocol to deliver the service data and detect connection problems.

The following describes functions of the BMS 3 in more detail.

User Profiles Management Function

The user profiles management function is responsible for (a) collecting, (b) classifying, (c) storing and (d) updating the data management profile database and (e) providing the BMS service matching function with user information. The process receives data from the BMS service store function regularly in run-time mode and stores the information in the respective data store. The user can have access to the data stores provided by the network operator to modify his personal settings to subscribe/enable/disable services.

Service Types Management Function

This function is responsible for (a) collecting, (b) classifying and (c) updating a data store of service types that can be provided by the BMS (for example, e-mail message delivery service for e-mail clients, tax calculator for PDA users, latest showbiz news for newsgroup subscribers etc). Data can be obtained through two sources, namely predefined service types, and/or discovered service types. Predefined service types are entered and maintained by the network operator and are entered in offline mode. Discovered service types are identified “on the fly” by the BMS when piconet devices of new types contact the BMS for the first time. Service type holds a set of useful attributes that, for example, tell the system how to inform a device if such a service has arrived, what kind of devices a particular type of service can be offered to etc.

Data is stored in a service type management database. There are many different types of service that can be potentially offered to a customer. The various different types of service could include special offers in the form of advertisements, MP3, E-Mail, JPG/BMP, basic text, video streams, and news. The differing types are managed in an intelligent manner, as not all the types are accessible to the diverse Bluetooth enabled device(s). It is the responsibility of the BMS matching function to match the appropriate service type with the correct Bluetooth enabled device.

Service Management Function

The service management function takes care of (a) collection, (b) storage, (c) management and (d) retrieval of actual services provided. Services can be entered to the data store in offline by the operator (maintaining the list of latest sports results, news groups etc) and in run-time by the system itself. An example of what would happen when an SMS message arrives is that it can be stored as a service for a particular user. When a user with a corresponding ID establishes a connection with a piconet and a BT-enabled PC contacts the BMS, the BMS service matching function launches the service management function and retrieves all available services for the user with such an ID and a piconet device of that type (PC with SMS support). An SMS message is among retrieved services. It is then be sent to the piconet along with other information including a destination and command. If the user leaves the piconet before the data is properly processed by the mobile terminal the BMS Service forwarding module in the BT environment will reply with an exception. As a result, the service will be returned back to the service management function and stored in the database. This will ensure that services will not get lost and an attempt to deliver the service data will be retried next time the user contacts a similar piconet.

If a service is provided by an external network it is registered in the database as a trigger. The actual service data is stored in the external content provider. When the BMS matching function identifies a service trigger it uses the trigger information stored in the database to inform the external network of a user availability. The external network than has to proved the service content to the customer. Triggers are registered in the service database by the mobile network operator or directly by an external network. To enable an external content provider to register triggers the network operator has to grant access to the service database to the later.

Data is stored in a services management database. Services are retrieved from this database by the BMS services matching function, which determines the type of devices that can be sent to a particular device, and sent to the Bluetooth enabled device(s) via the mobile terminals. If a service is undeliverable by the BMS service forward function, it is returned to the services management database where it is stored until a suitable device becomes available to receive it.

Predefined services are common services that are offered by a network operator to their users and their Bluetooth enabled devices. They can be services that are frequently requested by users. For example the service could be a map. The user has a Bluetooth enabled device that can display a file format that represents a map. Since this could be a most likely scenario, the network operator would see this as a potential predefined service. These services could be added offline, modified or deleted by the network operator as they see fit. The data would be fairly static i.e. a map as opposed to a share price which would be dynamic.

It is quite possible that the BMS will, during its lifetime, receive certain services and service types that it as of yet does not support or has no knowledge of—this will more than likely come from an external source. When it does receive a particular service from an external source intended for a particular user it adds the new service type to the service type database From now on it can recognise the type of service and begin matching up users capacity with the new service. The service itself is added to the service database and the user's profile is updated to reflect the fact that he received a service of the new type.

After creation of the user profile in the database it is regularly updated almost every time a user's Bluetooth enabled device connects to the BMS. The profile is constantly refined in order to ensure that the user is only offered the services that are appropriate to those users types of devices and their preferences and interests. The information here is utilised by the BMS service store function to store the users profile. It is also used by the BMS matching function to match the appropriate services to the appropriate users' devices. If, for example, a user requests a particular service from the BMS, say the latest goal in a football match, then the BMS could store in that users profile the information relating to this request i.e. what teams were playing, what competition the game was being played in etc. This information could be refined the more a user requests this type of service. Now the user profile database stores the knowledge that the user has a Bluetooth-enabled device that can support video stream but also other information such as what team the user supports, what football competition the user is interested in etc. Now the network operator can make customised service offers based on the data stored in the user profile.

External Services Data Flow

These are services that come from outside the operator network domain. It is conceivable that the user might want to access services that the operator either cannot support or won't support or a service might come from outside the network operator's domain intended for the user. For example, if the network operator were to receive an e-mail for a user via the Internet or indeed from another network operator then it must have a process by which it can forward on the e-mail to the user's Bluetooth-enabled device. These services, which can also be called run-time services, (i.e. dynamic, constantly being updated) are handled by the services management function in the BMS. They will be used by the BMS matching function that matches up the service to be processed with the appropriate Bluetooth enabled device. External services can be registered in the services database as triggers. In that case actual service data is stored in the external network. The external network is informed by the BMS of the user availability and is responsible for delivering the user data to the customer.

Use Case Scenarios

Scenario 1: Forwarding an E-mail

Extending the reach of a 3G network to include temporary, distant piconets, which will include (Bluetooth/Wireless-enabled) devices.

A network operator wishes to exploit devices not normally residing with the operator's network, thus in effect extending their 3G network to now include distant piconets. To do this the network operator must have a mechanism by which the operator has both knowledge of such devices and a means by which the operator can communicate with them.

A mobile terminal user wishes to exploit devices in physical proximity to the mobile terminal when using the mobile terminal. This is done via the BMS connection function. The mobile terminal also has the facility to communicate with a distant 3G network. The mobile terminal can become, in effect, a bridge between the network operator's 3G network, which operates over an air interface and devices in close physical proximity to the mobile terminal, which operate over a wireless Bluetooth interface, which is dependant on the mobile terminal and devices being within a given range of each other

A mobile terminal user is often in the field, out of the office, etc and relies on the mobile terminal for communication of data, not necessarily solely for voice. A mobile user is often on site, in the presence of a Bluetooth network, or has a laptop computer, or PDA, which can deal with many forms of communication that is normally send only to the mobile terminal: email, and files, for example.

A network operator wishes to increase customer use and customer satisfaction with file-delivery from their 3G Network to these devices. The network operator uses the invention to obtain a picture of available non-network devices in proximity—in communication range—of the mobile terminal. The network operator uses this information to extend the reach of their network, temporarily considering non-network elements in proximity to the mobile terminal as devices in the operator's network. This is achieved by sending information to the mobile terminal along with commands to the part of the invention in the mobile terminal, which controls the use of non-network elements. These commands will instruct the mobile terminal in how to deal with the communication from the operator's network, for example to forward the communication onto a devices in the new temporary addition to the network.

Example: Forwarding an Email

Here is detailed an example of the scenario stated above. The network operator's 3G network can receive data/communication from external networks, for example the Internet. This could be e-mail. This e-mail is required to be sent to a particular registered user's device. This e-mail (not only e-mail, anything that is required to be stored) storage facility is handled by the BMS Service Store module of the invention.

When the mobile terminal communicates with the operator's network informing the network of its presence and the presence of devices in close proximity to the mobile terminal the network operator checks to see if the data on the devices sent by the mobile terminal includes the device that the operator is required to send the e-mail to. If so, then it will send the e-mail to the mobile terminal in the form of data (the email), location/destination data (where the e-mail is to be forwarded onto and command data on how to deal with the incoming data. The BMS service delivery handles the means by which data is forwarded on via the mobile terminal.

If the network operator is unable to send the various data onto the mobile terminal then a timeout/error mechanism is activated by which the data is returned to the network operator to be stored so it can be re-sent at a later date when possible (as described above).

Scenario 2: Use of GPS-Enabled Devices: Car Location Information

The GPS Bluetooth enabled device in the car receives traffic information updates from the network based on the location of the car. This location information will be determined by the network operator via a mobile terminal.

A network operator will be able to send relevant and up-to-date traffic information to a user's Bluetooth-enabled device via a mobile terminal. This will be achieved by the use of the BMS service matching function. This in turn uses the services management function to retrieve the services that are appropriate to that user.

A mobile terminal user wishes to retrieve the latest traffic news appropriate to his location. The first part of this process is done via the BMS connection function in the invention. A GPS Bluetooth enabled device in the car sends its data (GPS location) to a Bluetooth enabled Mobile Terminal. This mobile terminal forwards this data the network operator who processes it and sends back the traffic information.

A mobile terminal user is often out of the office in the car. To enable the user to get from location to location quicker and therefore being more productive they would need a means of avoiding traffic jams, taking less busy routes, running into road diversions etc. The GPS Bluetooth enabled device can only give the user's location.

A mobile terminal can only receive traffic information from the network operator but it could be widely inaccurate given the user's current location or be too lightweight in the event that the network operator is attempting to just cover all the main traffic news issues. However the invention offers the facility to gather the location from the GPS Bluetooth enabled device, pass it, via a piconet, to a mobile terminal which in turn sends it via an air interface to the BMS. The BMS service matching function correlates the relevant traffic information and sends it back to the Mobile Terminal with the appropriate commands, destination, and service data.

Example: Forwarding an Email

Here is detailed an example of the scenario stated above. User A is driving along in his car. He has to get o a very important meeting. He wonders if there will be any major traffic problems that could possibly delay him. Using the GPS Bluetooth enabled device in his car to determine his exact location, and using the piconet that has been formed with his mobile terminal the data can be transferred from the GPS Bluetooth enabled device to the mobile terminal to the BMS on the network operator side. The network operators, on receipt of this data, processes it and using the BMS service matching function determines the correct data to be sent back to the user.

Scenario 3: Providing Voice as a Service to BlueTooth Enabled Devices

Enabling the mobile operator to provide voice services to multiple BlueTooth-enabled devices using the mobile terminal as a bridge to available user piconets.

The customer would like to receive voice messages from the operator and redirect them to other devices. This would be done at no extra cost to the user and will enable such features as hands-free headsets for cars, intercom meeting's (conference calls) using mobile phones or laptop computers etc.

Knowing that the service is located in one of the data stores in the Global Network environment controlled by the BMS the customer would be able to configure his profile by accessing BMS user data store through the web or any other means provided by the network operator. By personalising his settings the user could disable or enable the feature, register himself as a member of a conference call audience etc.

The operator wishes to make his voice services available to the customer not only through the use of the mobile terminal but through the use of other multiple BlueTooth devices such as handsets and other BlueTooth enabled terminals. This would increase the popularity of such service, as more customers would be interested in transmitting voice message to other mobile phone users or receive calls or listen to the music in a car (hands-free phone sets) and potentially increasing the market of the mobile network operator.

While on a train a group of people working in the same company receives an important call from the head office. The person who receives the call first wants his colleagues to participate in a discussion. To do so all of them gather in one area (compartment) having their Bluetooth enabled mobile phones or headsets turned on. All of the members of the audience on the train to access the network operator's website using their WAP enabled mobile phones or laptop computers and modify their profiles if necessary. Optionally this could be achieved by changing settings in Bluetooth enabled mobile phones. After user profiles are adjusted everybody in the area could listen to their colleagues from the head office talking to them from their office and participate in the conversation. The head office audience can be using the standard intercom service provided by an ordinary phone or also be in the same situation as the group of people on the train using their Bluetooth enabled mobile phones or headsets to receive broadcasted messages.

Optionally, instead of using the mobile phones a Bluetooth enabled laptop computer with intercom capability can be involved. In that case a piconet between the mobile terminal of the person who receives the call and a laptop computer can be established with everybody listening to the loudspeakers and using the laptop's internal microphone. The laptop computer is Bluetooth enabled and has special software installed that allows such functionality as receiving incoming data from the Bluetooth chip, redirect the output to loudspeakers, processing voice data received by the internal microphone etc).

In the scenario described above, the group of people on the train or on site can all participate in a discussion, even if the intercom service is not available. The customer saves the cost of making another call to an intercom-enabled phone, if one is available in the area. A discussion can take place in a crowded area (an airport) since everybody will be using his or her mobile phones and the interference will be minimised.

Description of BMS Activity Involved

When Bluetooth enabled devices capable of processing voice data such as Bluetooth enabled mobile phones, headsets, laptops etc establish a connection with a mobile terminal. The mobile terminal will serve as a bridge between the piconet and the Global Network environment. The BMS connection function sends information to the BMS modules residing in the operator's domain.

The piconet data sent to the Global Network includes the list of available Bluetooth devices, their capabilities and user IDs supplied by Bluetooth devices. Customer IDs will be used by the BMS to identify users participating in the broadcast.

The BMS Matching mechanism uses detected capabilities of devices and user IDs to find matching services available in the data store (voice messages). If one of the users did not register for the voice broadcast service his address will be excluded from the service data that will be sent back to the mobile terminal. The BMS service delivery function will then block the device from receiving the voice message.

Users participating in the piconet should have their profiles set up accordingly. This can be done by, for example, accessing the operator's web site that will execute update queries against BMS data stores of user profiles located in the operator's domain.

The BMS service delivery function receives the service data (voice messages). It is the responsibility of the BMS Service Delivery module to correctly identify the final destination of the service data. Addresses of piconet devices received from the Global Network will be used for this purpose. Bluetooth protocols serve as transport for the data and the special command protocol handles the mechanism for redirecting voice messages between devices and identifying final destination for the data.

Software applications running in the application layer of the Bluetooth protocol stack handle the intercom voice messages from all the participating Bluetooth enabled devices and control the data flow of the process. Service offers are customised for every user that is connected to the piconet and ensure that an accidental user who enters the piconet area is blocked from receiving and transmitting voice messages.

Scenario 4: Customization of Services Offered by the Network Operator

A network operator wishes to offer customised services to the user based on user information and service data available to the operator. Mobile devices should assist the operator in delivering services/service data/commands generated by the network to piconet devices and provide closer communication between the user devices and the network operator.

Mobile terminal users wish to access a wider yet customised set of services available from the operator and supported by Bluetooth enabled devices. A user wishes to enable Bluetooth devices to offer services in a more intelligent way using the information obtained from the global network—i.e. “subconscious” data transfers, customised services based on user profiles etc.

Bluetooth enabled devices usually support a narrow set of services that are provided to the user upon establishing a piconet connection. Certain services could be configured (customised) if Bluetooth devices had the knowledge about the user preferences (user profile) collected by the network operator. Certain types of services could be updated, added or constantly improved if data available to the network operator was available to Bluetooth devices.

The network operator system contains data about the user (user profiles, preferences etc) and services that is essential to service customisation. The data (data stores) are not yet available to the Bluetooth devices.

The BMS extends Bluetooth devices reach by using the BMS connection function and obtaining data from the operator's data stores. Data customisation and delivery is carried out through the BMS service matching and service delivery function.

The BMS connection function, residing in the mobile terminal, takes care of gathering piconet and user data and submitting it to the network operator. The data, combined with information stored in the operator's domain by the BMS service store function is used to customise services available for types of devices that participate in active piconet connection. The BMS service matching function performs the task of processing services and user data stored in internal databases and submitting offers based on mobile terminal requests. The BMS service forwarding function receives processed data from the operator and uses it to provide services through Bluetooth devices.

Example—a Bluetooth-enabled PDA with e-mail support forms a piconet with a mobile terminal that contains a BMS connection function. The module gathers information about the Bluetooth devices participating in the piconet and compiles piconet data that includes information obtained from devices and the mobile terminal (including user ID). The piconet data is then sent to the BMS service store function residing in the operator's domain. The BMS service store function uses customer's data and piconet device types to update user profiles and services data stores. Then BMS service matching function is activated to retrieve available services that can be offered to a customer with this ID. Services are further filtered to accept only those that can be processed by Bluetooth devices that from the current piconet. Since PDA with e-mail support is detected in the user's vicinity, e-mail messages stored in the database of undelivered services become available. The user profile database is used to further filter services. For example, knowing that the customer disabled incoming messages from certain group of people the BMS service matching function will exclude certain e-mails from the list of offered services (service customisation based on the type of Bluetooth devices). Messages (if any) are then forwarded back to the piconet through BMS service delivery function. The module is responsible for implementing the error/retry mechanism and sending undelivered services back if the piconet is no longer active (the user left the area). If e-mail messages are successfully delivered, the PDA should notify the user of their arrival or simply display them on screen.

Scenario 5: Supporting Predefined and External Services Provided by the Network Operator

The operator wishes to offer predefined services such as the latest currency rates, television program etc as well as external or “real-time” services coming from external sources (e-mails, news group messages etc). The operator should be able to define new services offline and make them available to the customer.

The user wishes to subscribe to as many different types of services as possible. Among those there should be standard services such as e-mails and SMS messages.

The user must have an access to the full range of specific offers available from the network operator.

The operator stores service information in internally-supported data stores. Predefined services information is entered by the operator in offline mode and becomes available to the user upon his connection to the BMS service matching function.

Services originating in external sources such as Internet Service Provider (e-mails, news updates) and those coming from the operator's network (voice and text messages) are stored in the database as well.

The BMS service matching function is responsible for accessing the service information in data stores, identifying their types and forwarding appropriate services to interested users. Users can subscribe to different predefined services. Service subscriptions are stored in user profile databases are later used by the BMS service matching function to identify appropriate offers to be sent to a user.

Example—User's mobile phone (mobile terminal) detects a piconet that contains a Bluetooth-enabled PDA and a computer. The PDA contains software that performs financial calculations based on exchange rates store in a database. The BMS connection function obtains data from the piconet devices including their types and capabilities. Device data together with user ID is sent to the operator. After the store function processes the data, BMS service matching function scans service data stores of predefined and real-time services. For example, an update table of foreign currencies (predefined service maintained by the operator) and an e-mail message are available in the database (real-time service).

The BMS service matching function detects capabilities of the PDA and the user PC and accepts both services. Service data is then forwarded to the user's mobile terminal. The terminal reroutes services to relevant devices (table of exchange rates is sent to the software module in the PDA and the e-mail message is forwarded to the PC). In this case the predefined service is offered and accepted by the PC “subconsciously”. The user can explicitly subscribe for receiving currency rates or disable this feature.

Also, the operator can create a new predefined service such as downloading TV programs to user's PCs. User may subscribe for such an offer at any time. The user can be notified of the arrival of a new service and can reject the request to update the database of currency rates.

Scenario 6: Enabling Subscription and Blocking of Services

The network operator can support a wide range of services and provide them to the user. To minimise data traffic the operator wishes to personalise service offers by updating user information and using it for narrowing set of services offered to the user.

The user wishes to disable or enable services available from the operator. The action should be done once for each service to disable or enable delivery of service data to all compatible Bluetooth—enabled devices.

The user profile data store maintained by the operator contains all relevant information about the user and is used for the purpose of service subscription and blocking. The operator can provide numerous ways for a user to change the data. It can be done, for example by accessing the operator's web site, or sending an SMS message to the operator.

Example—the user decides not to receive rugby matches updates, which are normally sent to a Bluetooth—enabled PDA or a PC. Once this service is blocked for example, by using operator's web page none of the compatible Bluetooth devices will receive a service offer from the operator.

The user accesses Network operator's site and alters his settings (profile) to disable rugby match updates. The changes made by the user will be saved in the data store of user profiles. When the user's mobile terminal forms a piconet with a PDA or PC the BMS connect function sends information about piconet devices to the operator. After the BMS service store function pre-processes the data the BMS service matching function starts scanning for available services in the data store. Suppose a new service is found in a data store. The Service matching function then gets user's profile data from the user data store and finds out that this type of service is explicitly disabled by the user through accessing the web site. The user can enable (subscribe for) certain type of services that become available from the operator. The user can always change his preferences by accessing the network operator's site.

The invention is not limited to the embodiments described but may be varied in construction and detail.

1. A communication method carried out by a user mobile device and a remote management system, the method comprising the steps of:—
(a) the mobile device automatically capturing consumer data from a wireless local area network of consumer devices according to a local wireless protocol,
(b) the mobile device automatically uploading said captured data to the management system via a mobile network; and
(c) the management system receiving the captured data and using it to automatically update a user profile database with user profile data for use in making service offers to the user.

2. A method as claimed in claim 1, wherein the method comprises the further step of the management system making service offers to the user according to the user profile data.

3. A method as claimed in claim 1, wherein the method comprises the further step of the management system making service offers to the user according to the user profile data, and the management system automatically pushes service offers to the user.

4. A method as claimed in claim 1, wherein the wireless local area network is a piconet operating according to the Bluetooth standard.

5. A method as claimed in claim 1, wherein the capturing step (a) comprises capturing:
attributes of said consumer devices;
user-specific data from a mobile device memory; and
status data for the wireless local area network including data relating to addition or deletion of consumer devices.

6. A method as claimed in claim 1, wherein the step (b) is carried out by a collection function in the mobile device and a data store function in the management system.

7. A method as claimed in claim 1, wherein the uploading step (b) is performed by the mobile device interfacing with the local wireless network, interfacing with the mobile network, and bridging between said interfacing operations.

8. A method as claimed in claim 7, wherein the updating step (c) is performed by a store function of the management system, and it comprises storing a return address for service offers.

9. A method as claimed in claim 1, wherein the updating step (c) comprises the sub-steps of:—
updating the user profile database with captured user profile data,
updating a service database with captured service data originating in the wireless local area network, and
updating captured connection data for pushing service offers to the user.

10. A method as claimed in claim 1, wherein the method comprises the further step of the management system making service offers to the user according to the user profile data, and wherein the updating step (c) comprises updating a service type database with user profile data, and an external entity updating said database with service type data.

11. A method as claimed in claim 1, wherein the method comprises the further step of the management system making service offers to the user according to the user profile data, and wherein the updating step (c) comprises updating a service type database with user profile data, and an external entity updating said database with service type data, and wherein the steps of the management system making service offers comprises the sub-steps of:—
retrieving user profile and service data, and
matching the service data with the profile data to determine a suitable service.

12. A method as claimed in claim 11, wherein the service offer step comprises the further sub-steps of matching the service data with data relating to a user service request.

13. A method as claimed in claim 11, wherein the management system stores service type attributes in a service type database and uses said attributes for matching the service data with the profile data.

14. A method as claimed in claim 11, wherein a service delivery function of the mobile device makes the service offer in response to instructions from a service matching function of the management system.

15. A management system comprising:
means for interfacing with a mobile device in a wireless local area network of consumer device;
a data store function comprising means for receiving captured consumer data from the mobile device, and for using the captured data to update a user profile database;
a service management function comprising means for updating a service database with service data; and
a service matching function comprising means for parsing user profile data and service data to determine service offers to be made to the mobile device in a personalised manner.

16. A system as claimed in claim 15, wherein the system comprises a service type function comprising means for updating a service type database with service type attributes, and the service matching function comprises means for using said attributes for choosing personalised services to offer.

17. A system as claimed in claim 15, wherein the system comprises a service type function comprising means for updating a service type database with service type attributes, and the service matching function comprises means for using said attributes for choosing personalised services to offer, and wherein the system comprises means for updating the service type database using data for services provided by external entities.

18. A system as claimed in claim 15, wherein the system comprises a service type function comprising means for updating a service type database with service type attributes, and the service matching function comprises means for using said attributes for choosing personalised services to offer, and wherein the system comprises means for updating the service type database using data for services provided by external entities, and wherein the system comprises means for registering a service type from an external entity as a trigger.

19. A mobile device comprising:
an interface for interfacing with consumer devices in a wireless local area network,
an interface for interfacing with a mobile network,
means in the consumer device interface for routing captured device data to the mobile network interface, and
means in the mobile network interface for uploading said captured data to a remote management system.

20. A computer program product comprising software code for performing the management system steps of claim 1 when executing on a digital computer.
